(19) United States
(12) Patent Application Publication
(10) Pub. No.: US 2026/0224022 A1
(43) Pub. Date: Aug. 6, 2026

(54) TILTABLE TABLETOP MOUNTING BRACKET FOR AUDIOVISUAL DEVICE

(71) Applicant: Crestron Electronics, Inc., Rockleigh, NJ (US)

(72) Inventors: Marc Happes, Stoughton, MA (US); Kian-Mun Kong, Rivervale, NJ (US)

(73) Assignee: Crestron Electronics, Inc., Rockleigh, NJ (US)

(21) Appl. No.: 19/245,465

(22) Filed: Jun. 23, 2025

Related U.S. Application Data
(60) Provisional application No. 63/753,652, filed on Feb. 4, 2025.

(51) Int. Cl. A47B 21/04; F16M 11/10; H04R 1/02

(52) U.S. Cl. CPC A47B 21/04; F16M 11/10; A47B 2220/0036; A47B 2220/0091; F16M 2200/024; H04R 1/026

(57) ABSTRACT

A mounting bracket is disclosed. A first plate is configured to be disposed atop a horizontal mounting surface. A second plate is configured to be securable to an audiovisual device. A third plate is configured to extend from the first plate to at least near the second plate. At least one hinge/clutch assembly has a pivot axis. The first plate and the third plate are each attached at one end to the at least one hinge/clutch assembly such that an angle between the second plate and the third plate is adjustable by rotating the second plate at least part way about the pivot axis of the at least one hinge/clutch assembly.

### CROSS-REFERENCE TO RELATED APPLICATIONS

This application claims the benefit of the filing date of U.S. Provisional Ser. No. 63/753,652 (“the '652 application”), filed Feb. 4, 2025, the disclosure of which is incorporated herein by reference.

This application is also related to U.S. application Ser. No. 29/988,545, titled “TABLETOP MOUNTING BRACKET FOR ELECTRONIC DEVICE”, filed Feb. 4, 2025, the same date as the '652 application, and the disclosure of which is incorporated herein by reference.

### BACKGROUND OF THE INVENTION

### Technical Field

The present embodiments relate to mounting brackets and, more particularly, to mounting brackets that are suitable for placement atop a table, credenza, or other mounting surface and configured for tiltable mounting of an audiovisual device atop of.

### Background Art

In recent years, the percentage of the global workforce that is on a remote work schedule or hybrid working schedule has grown significantly. With their workforces now being scattered geographically, businesses are faced with the challenge of giving each worker access to the tools needed to collaborate with other employees remotely. In response, there have been numerous innovations in collaboration technology in recent years that address this challenge.

One such innovation is video conferencing and, more recently, the introduction of professional video conferencing systems. These video conferencing systems are formed of various discrete components that individually function to capture and transmit video, audio, digital files, shared digital screens, and other content. By connecting these discrete components together, a unified solution is formed that facilitates long-distance communications and collaboration between individuals and groups.

Though modern smartphones and personal computers can achieve some of these functions using built-in and/or add-on features or devices, a professional video conferencing system must meet higher standards of video and audio quality, security, connectivity, system management, and scalability. Therefore, web-based video meeting platforms have been developed to carry out interactive virtual meetings in real-time among people located in different locations or geographic areas. Such platforms provide screen-sharing capabilities that enable users to share working documents within any sized group, present content, and perform live edits while receiving peer feedback.

Additionally, various types of technology and equipment are needed for a professional video conferencing system, including displays, cameras, microphones, and speakers. Though the choice of equipment often depends on user needs and the space used, it is desirable for a professional video conferencing system to employ professional video conferencing cameras with features such as speaker tracking and auto-framing to provide higher-definition video calls. It is also often desirable for a professional video conferencing system to incorporate higher-quality microphones that employ noise-canceling as well as to employ higher-quality speakers.

One approach to providing such cameras, microphones, and speakers for a professional video conferencing system is to obtain these devices separately, install each device individually in a conference room, and then integrate the devices into the video conferencing system. A more desirable alternative is to opt for an all-in-one video conferencing system such as the Crestron® Videobar 70 combines such higher-quality video conferencing cameras, microphones, and speakers in a single product.

The Crestron® Videobar 70 is an all-in-one-collaboration bar in which four high-resolution cameras, stereo speakers, and beamforming microphones are provided in a single, easily deployable device. The four high-resolution cameras are used to provide intelligent video capabilities that include group framing, speaker tracking, and picture-in-picture. A wide-angle camera is provided for full room views and to image individuals closer to the front of a room. Three narrow-field-of-view cameras are arranged in an array and can work together to capture individuals further away in high-resolution.

In many applications, such as in a conference room or a demonstration, it is desirable to mount the Videobar 70 atop a table, credenza, or other suitable mounting surface. It is also often desirable that the cables that are used to provide power and data connections to the Videobar 70 be hidden and not be visible to those participating in the video conference or attending the demonstration.

It is further desirable that the position of the Videobar 70 be tiltable so that the cameras of the Videobar 70 are best positioned to capture the desired field of view for a given conference room or other intended application.

It is therefore desirable to provide a mounting bracket that enables the installation of the Videobar 70 atop a table, credenza, or other mounting surface in accordance with the above.

### SUMMARY OF THE INVENTION

It is to be understood that both the general and detailed descriptions that follow are exemplary and explanatory only and are not restrictive.

### Disclosure of Invention

In accordance with an aspect, a mounting bracket comprises (a) a first plate configured to be disposed atop a horizontal mounting surface; (b) a second plate configured to be securable to an audiovisual device; (c) a third plate configured to extend from the first plate to at least near the second plate; and (d) at least one hinge/clutch assembly having a pivot axis, the first plate and the third plate each being attached at one end to the at least one hinge/clutch assembly such that an angle between the second plate and the third plate is adjustable by rotating the second plate at least part way about the pivot axis of the at least one hinge/clutch assembly.

According to a further aspect, a mounting bracket comprises (a) a first plate configured to be disposed atop a horizontal mounting surface; (b) a second plate configured to be securable to an audiovisual device, the second plate narrowing at one end to form at least one extension region, a first arm being disposed adjacent to one side of the at least one extension region and extending away from, and perpendicular to, a surface of the second plate; (c) a third plate configured to extend from the first plate to at least near the second plate, the third plate narrowing at one end to form at least one further extension region, a second arm being disposed adjacent to one side of the at least one further extension region and extending away from, and perpendicular to, a surface of the third plate; and (d) at least one hinge/clutch assembly having a pivot axis; (e) wherein (1) the first arm is disposed adjacent to the second arm and has an end portion that overlaps an end portion of the second arm, (2) a first opening formed in the end portion of the first arm overlies a second opening formed in the end portion of the second arm, (3) a body portion of the at least one hinge/clutch assembly is disposed on one side of the first and second openings, an end portion of the at least one hinge/clutch assembly is disposed on an opposing side of the first and second openings, and a remaining portion of the at least one hinge/clutch assembly extends through the first and second openings, and (4) the pivot axis extends through the first and second openings, an angle between the second plate and the third plate thereby being adjustable by rotating the second plate at least part way about the pivot axis of the at least one hinge/clutch assembly.

According to a still further aspect, a mounting bracket comprises (a) a first plate configured to be disposed atop a horizontal mounting surface, the first plate including (1) a first surface that is configured to face the mounting surface upon the first plate resting upon the mounting surface, and (2) an opposing second surface that is configured to face away from the mounting surface upon the first plate resting upon the mounting surface; (b) a second plate configured to be securable to an audiovisual device, the second plate including (1) a first surface that is configured to face the audiovisual device upon the audiovisual device being secured to the second plate, and (2) an opposing second surface that is configured to face away from the audiovisual device upon the audiovisual device being secured to the second plate, (3) the second plate narrowing at one end to form a pair of extension regions, each having a respective first arm disposed adjacent to one side of that extension region and extending away from, and perpendicular to, the second surface of the second plate; (c) a third plate configured to extend from the first plate to at least near the second plate, the third plate the third plate including (1) a first surface that is configured to face the at least one hinge/clutch assembly, and (2) an opposing second surface that is configured to face away from the at least one hinge/clutch assembly, (3) the third plate narrowing at one end to form a pair of further extension regions, each having a respective second arm disposed adjacent to one side of that further extension region and extending away from, and perpendicular to, the first surface of the third plate, wherein (4) the first arm that extends from each one of the pair of extension regions of the second plate is disposed adjacent to the second arm that extends from a corresponding one of the pair of further extension regions of the third plate and has an end portion that overlaps an end portion of that second arm, and (5) a first opening formed in the end portion of each first arm overlies a second opening formed in the end portion of its adjacent second arm; and (d) a pair of hinge/clutch assemblies, wherein (1) an ending of one of the pair of extension regions of the second plate and an adjacent ending of one of the pair of further extension regions of the third plate are each attached to a respective one of the pair of hinge/clutch assemblies, such that (A) a body portion of that hinge/clutch assembly is disposed on one side of the overlying first and second openings respectively formed in the end portions of the first and second arms that respectively extend from one of the pair of extension regions of the second plate and the one of the pair of further extension regions of the third plate, (B) an end portion of that hinge/clutch assembly is disposed on an opposing side of the overlying first and second openings, and (C) a remaining portion of that hinge/clutch assembly extends through the overlying first and second openings, and (2) an ending of another of the pair of extension regions of the second plate and an adjacent ending of another of the pair of further extension regions of the third plate are each attached to another of the pair of hinge/clutch assemblies, such that (A) a body portion of that hinge/clutch assembly is disposed on one side of the overlying first and second openings respectively formed in the end portions of first and second arms that respectively extend from another of the pair of extension regions of the second plate and another of the pair of further extension regions of the third plate, (B) an end portion of that hinge/clutch assembly is disposed on an opposing side of the overlying first and second openings, and (C) a remaining portion of that hinge/clutch assembly extends through the overlying first and second openings, (3) the pair of hinge/clutch assemblies thereby having a common pivot axis, each one of the pair of hinge/clutch assemblies being configured to be rotatable about the common pivot axis upon exertion of a force on the second plate and to be fixed upon removal of the force; (e) wherein (1) the first plate includes (A) a front part disposed on a same side of the third plate as the first surface of the third plate, and (B) a back part disposed on a same side of the third plate as the second surface of the third plate, (2) a first gap is formed between the front part and the back part of the first plate, the first gap being configured to permit cabling of the audiovisual device to pass through the first gap, and (3) a second gap is formed between the second plate and the third plate, the second gap being configured to permit cabling of the audiovisual device to pass through the second gap.

### BRIEF DESCRIPTION OF DRAWINGS

The accompanying figures further illustrate the present embodiments.

The components in the drawings are not necessarily drawn to scale, emphasis instead being placed upon clearly illustrating the principles of the present embodiments. In the drawings, like reference numerals designate corresponding parts throughout the several views.

### BRIEF DESCRIPTION OF THE SEVERAL VIEWS OF THE DRAWING

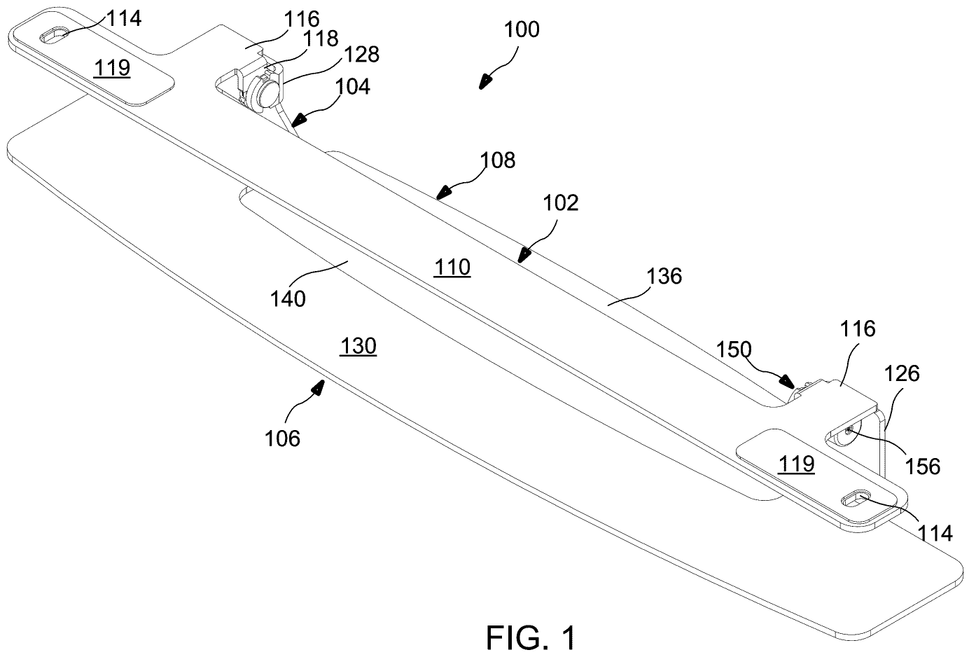

FIG. 1 is a top perspective view of a tiltable tabletop mounting bracket according to an embodiment.

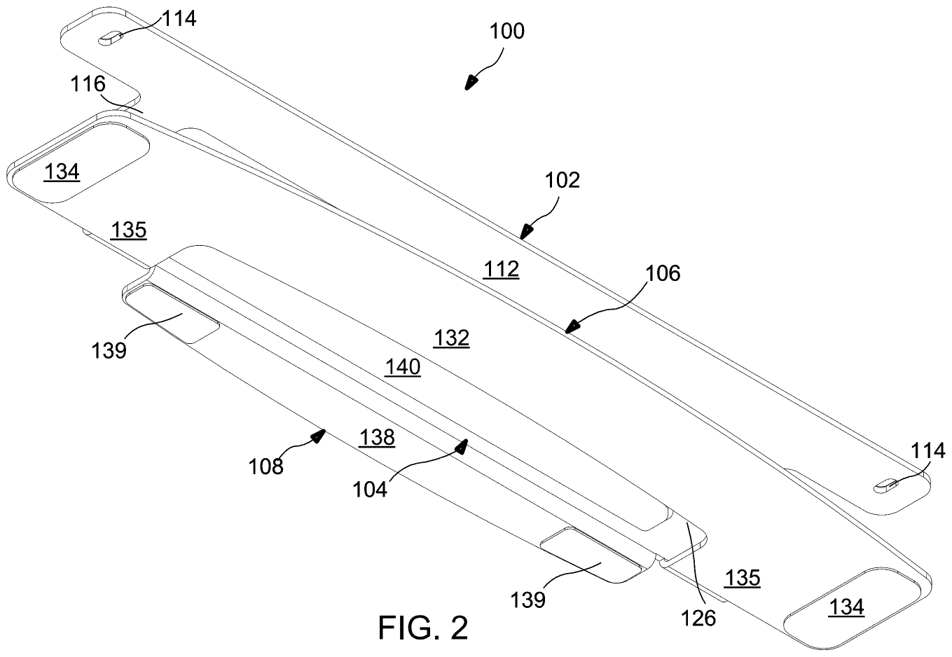

FIG. 2 is a bottom perspective view of the mounting bracket of FIG. 1.

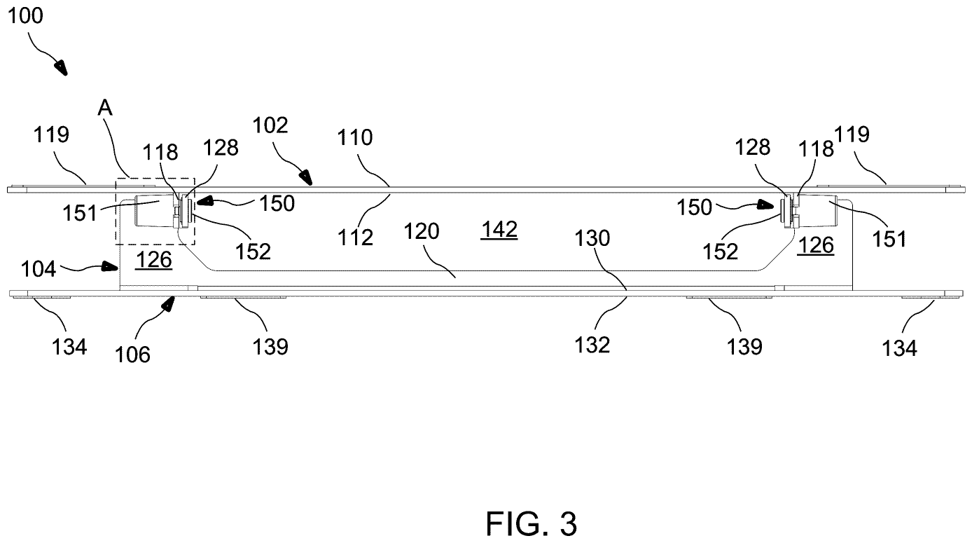

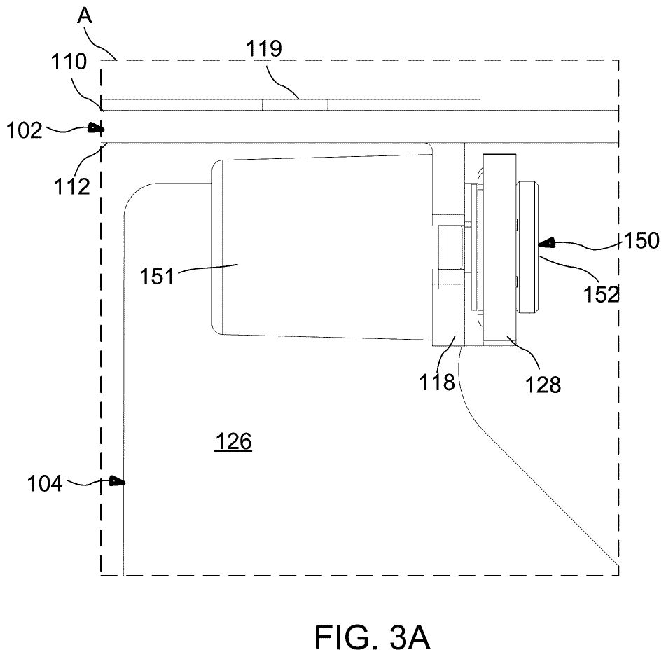

FIG. 3 is a front elevation view of the mounting bracket of FIG. 1.

FIG. 3A is an enlarged view of region “A” of the front elevation view shown in FIG. 3.

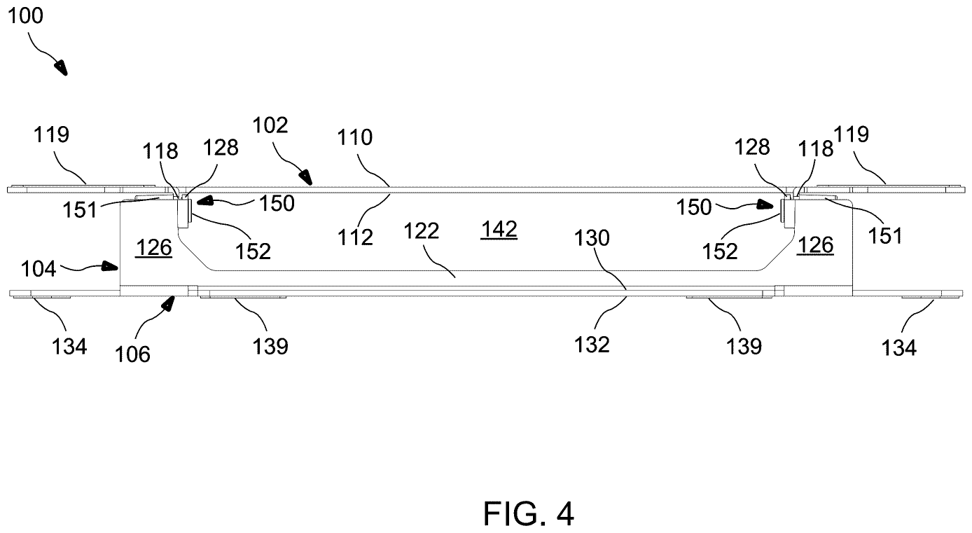

FIG. 4 is a rear elevation view of the mounting bracket of FIG. 1.

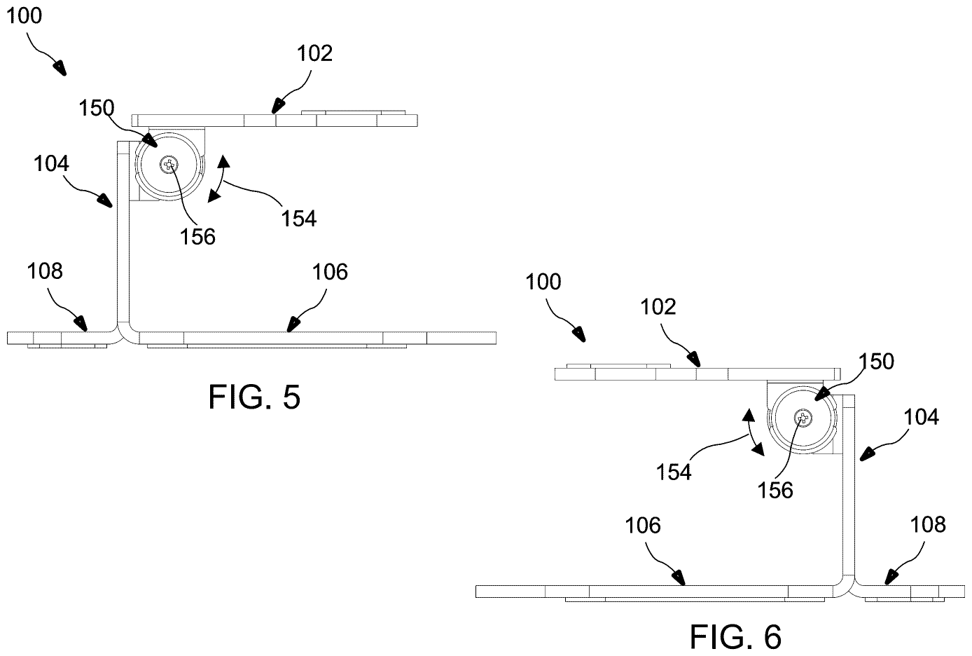

FIG. 5 is a left elevation view of the mounting bracket of FIG. 1.

FIG. 6 is a right elevation view of the mounting bracket of FIG. 1.

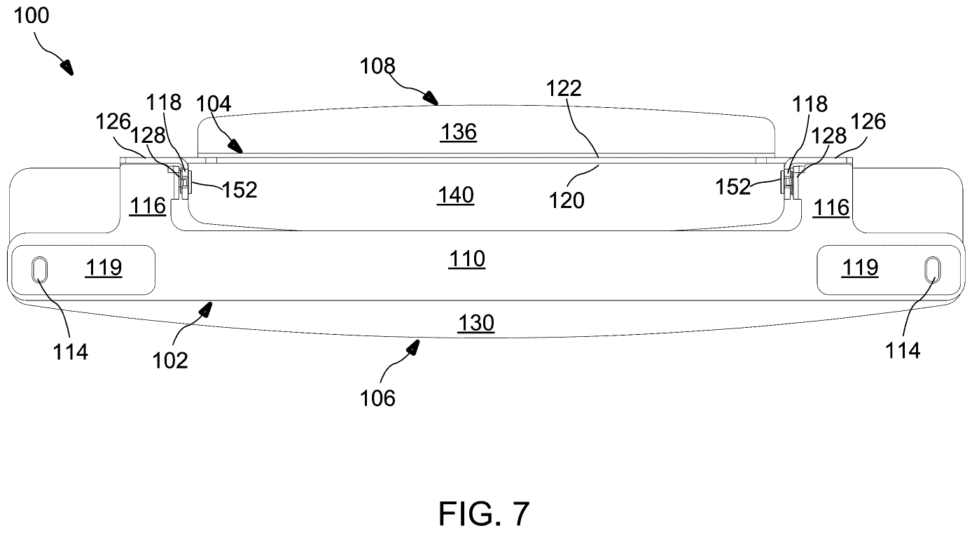

FIG. 7 is a top plan view of the mounting bracket of FIG. 1.

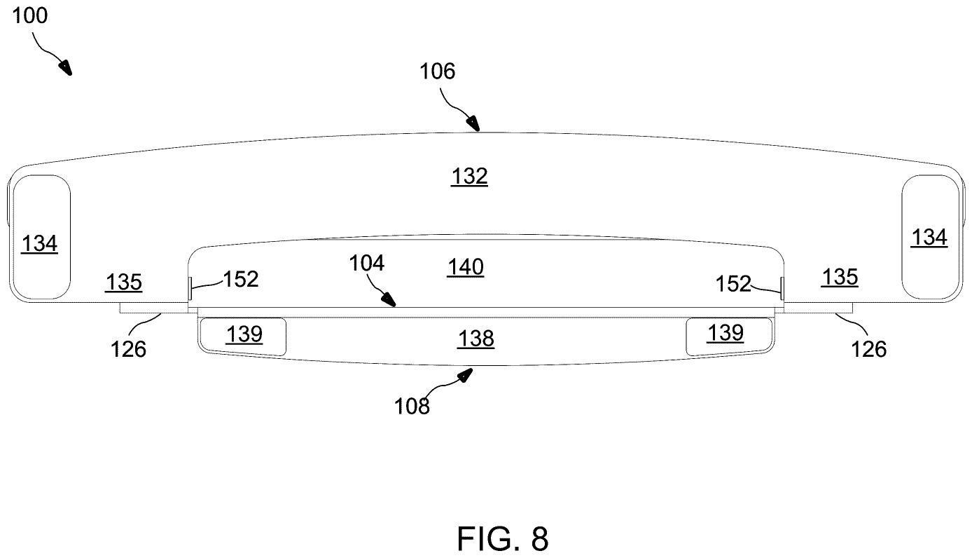

FIG. 8 is a bottom plan view of the mounting bracket of FIG. 1.

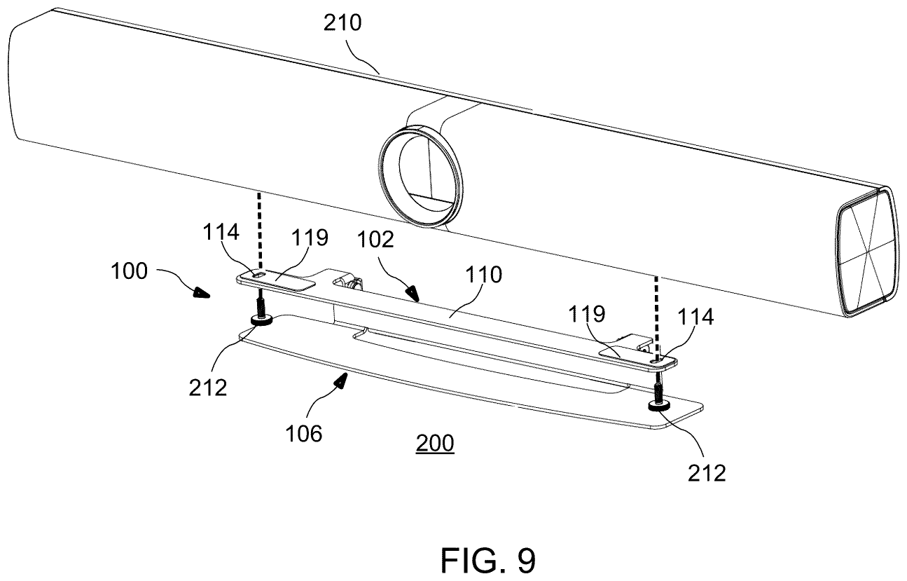

FIG. 9 shows an example of the installation of an audiovisual device to the mounting bracket of FIG. 1 upon the mounting bracket of FIG. 1 being positioned atop a mounting surface.

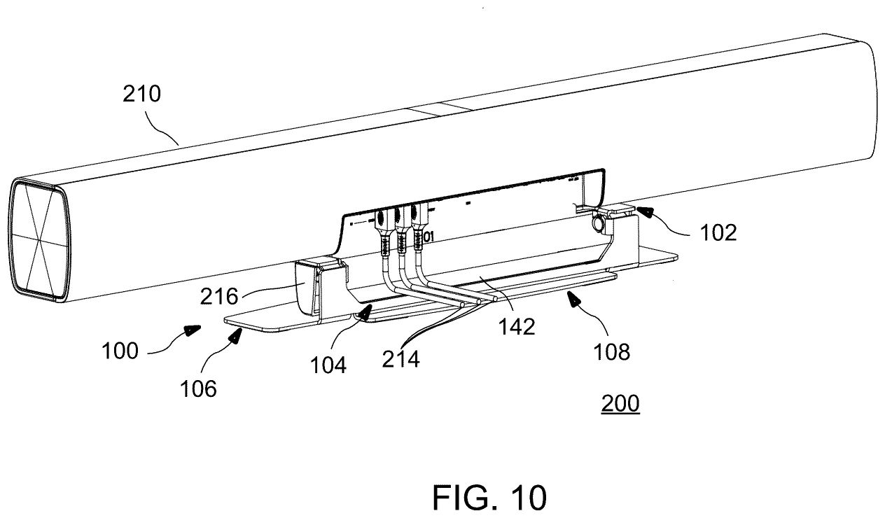

FIG. 10 shows an example of the routing of cables through the rear opening in the mounting bracket of FIG. 9.

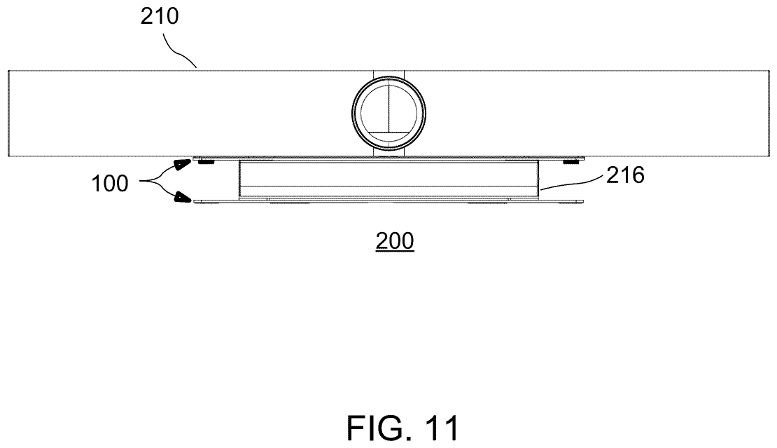

FIG. 11 shows an example of a completed installation of the audiovisual device to the mounting bracket of FIG. 10.

### DETAILED DESCRIPTION OF THE INVENTION

The present embodiments provide a tiltable tabletop mounting bracket that is configured for mounting a Crestron® Videobar 70 or other audiovisual device.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

### LIST OF REFERENCE NUMBERS FOR THE MAJOR ELEMENTS IN THE DRAWING

The following is a list of the major elements in the drawings in numerical order.
100 Mounting Bracket
102 Upper or Supporting Plate
104 Vertical Plate
106 Front Base Plate
108 Rear Base Plate
110 Top Surface of Upper Plate
112 Bottom Surface of Upper Plate
114 Screw Holes
116 Extension or Tab
118 Arm
119 Grip Pad
120 Front Surface of Vertical Plate
122 Rear Surface of Vertical Plate
126 Extension or Tab
128 Arm
130 Top Surface of Front Base Plate
132 Bottom Surface of Front Base Plate
134 Grip Pad
135 Extension or Tab
136 Top Surface of Rear Base Plate
138 Bottom Surface of Rear Base Plate
139 Grip Pad
140 Pass-Through Opening
142 Pass-Through Opening
150 Hinge/Clutch Assembly
151 Assembly Body
152 End Portion
154 Path of Rotation
156 Pivot Point
200 Audiovisual Device
212 Mounting Screws
214 Cables
216 Cable Shroud

### MODE(S) FOR CARRYING OUT THE INVENTION

The embodiment described herein in the context of a tiltable tabletop mounting bracket, but is not limited thereto, except as may be set forth expressly in the appended claims.

Referring first to FIGS. 1-8, a mounting bracket 100 for tiltable mounting of an audiovisual device, such as a Crestron® Videobar 70, atop a tabletop or other suitable mounting surface is shown according to an embodiment. More particularly, FIG. 1 is a top perspective view of the mounting bracket 100, FIG. 2 is a bottom perspective view, FIG. 3 is a front elevation view, FIG. 3A is an enlarged view of region “A” of FIG. 3, FIG. 4 is a rear elevation view, FIG. 5 is a left elevation view, FIG. 6 is a right elevation view, FIG. 7 is a top plan view, and FIG. 8 is a bottom plan view. In each of the figures, like reference numerals refer to like elements.

The mounting bracket 100 includes an upper or support plate 102, a vertical plate 104, a front base plate 106, a rear base plate 108, and a hinge/clutch assembly 150.

The upper or support plate 102 is configured to support an audiovisual device, such as the Videobar 70, and includes a top surface 110 that is configured to face the audiovisual device when the audiovisual device is mounted to the upper or support plate 102. An opposing bottom surface 112 is configured to face away from the audiovisual device when the audiovisual device is mounted. A pair of screw holes 114 are formed in, and extend through, the upper plate 102 and are configured to receive screws for securing the Videobar 70 or other audiovisual device to the upper plate 102. A pair of grip pads 119 are provided atop the top surface 110 and are configured to prevent the Videobar 70 or other audiovisual device from slipping off of the top surface 110 when the Videobar 70 or other audiovisual device is disposed atop the top surface 110 prior to being secured to the upper or support plate 102.

One end of the upper plate 102 narrows to form a pair of tabs or extensions 116 that are continuous with the remainder of the upper plate 102. An arm 118 is located at one side of each tab or extension 116, near an end of that tab or extension 116. The arm 118 extends away from the bottom surface 112 in a direction perpendicular to the bottom surface 112. One end of each arm 118 typically includes a substantially 90-degree bend where the arm 118 is joined to, or is continuous with, the side of the tab or extension 116. Another end of the arm 118 typically includes a curved end surface and has an opening (not shown) that passes completely through the width of the arm 118.

The front base plate 106 and the rear base plate 108 are configured to contact the tabletop or other mounting surface when the mounting bracket 100 and is situated atop the tabletop or other mounting surface.

The front base plate 106 includes a top surface 130 and an opposing bottom surface 132. The bottom surface 132 is configured to face the tabletop or other mounting surface when the mounting bracket 100 is positioned atop the tabletop or other mounting surface. The top surface 130 is configured to face away from the tabletop or other mounting surface. A pair of grip pads 134 are provided atop the bottom surface 132 and are configured to prevent the bottom surface 132 from slipping off of the tabletop or other mounting surface. One end of the front base plate 106, adjacent to the rear base plate 108, narrows to form a pair of tabs or extensions 135 that are continuous with the remainder of the front base plate 106.

The rear base plate 108 includes a top surface 136 and an opposing bottom surface 138. The bottom surface 138 is configured to face the tabletop or other mounting surface when the mounting bracket 100 is positioned atop the tabletop or other mounting surface. The top surface 136 is configured to face away from the tabletop or other mounting surface. A pair of grip pads 139 are provided atop the bottom surface 138 and are configured to prevent the bottom surface 138 from slipping off of the tabletop or other mounting surface.

A pass-through opening 140 is in a region formed between the pair of tabs or extensions 135 of the front base plate 106. The opening 140 also extends between a front part of the front base plate 106 and the rear base plate 108. The opening 140 provides a pass-through for power and data cables to be run to the Videobar 70 or other audiovisual device.

The vertical plate 104 extends from one end upward from the front base plate 106 and the rear base plate 108 and terminates at another end at a location in proximity to the upper plate 102. The vertical plate 104 may be joined at the one end to either the front base plate 106, the rear base plate 108, or both. Alternatively, the vertical plate 104 may be continuous with one or both of the front base plate 106 and the rear base plate 108.

The vertical plate 104 includes a front surface 120 and an opposing rear surface 122. An upper region of the vertical plate 104 narrows to form a pair of tabs or extensions 126 that are continuous with the remainder of the vertical plate 104. An arm 128 is located at one side of each tab or extension 126, near an end of that tab or extension 126. The arm 128 extends away from the front surface 120 in a direction perpendicular to the front surface 120. One end of each arm 128 typically includes a substantially 90-degree bend where the arm 128 is joined to, or is continuous with, the side of the tab or extension 126. Another end of the arm 128 typically includes a curved end surface and has an opening (not shown) that passes completely through the width of the arm 128.

A pass-through opening 142 is located in a region formed between the pair of tabs or extensions 126 of the vertical plate 104. The opening 142 provides another pass-through for power and data cables to be run to the Videobar 70 or other audiovisual device.

A pivot/clutch assembly 150 includes an assembly body 151, an end portion 152, and an intermediate section (not shown) located between the assembly body 151 and the end portion 152. Such pivot/clutch assemblies and their structure and operation are known in the art.

In an assembled mounting bracket 100, the vertical plate 104, the front base plate 106, and the rear base plate 108 are arranged together in the manner shown in FIGS. 1-8. The upper or support plate 102 and the vertical plate 104 are positioned relative to each other using the pivot/clutch assembly 150, also in the manner shown in FIGS. 1-8. That is, the tabs or extensions 116 of the upper or support plate 102 are arranged to be near the tabs or extensions 126 of the vertical plate 104. More specifically, an arm 118 of the upper plate 102 is arranged to be adjacent to, and facing, a corresponding arm 128 of the vertical plate 104 such that the openings (not shown) in the arms 118 and 128 overlie each other. Further, the other arm 118 of the upper plate 102 is arranged to be adjacent to, and facing, the other arm 128 of the vertical plate 104 such that the openings (not shown) in those arms 118 and 128 similarly overlie each other.

Connecting the upper or support plate 102 and the vertical plate 104, as well as controlling the tilting of the upper or support plate 102 with respect to the vertical plate 104, are a pair of a hinge/clutch assemblies 150. Each hinge/clutch assembly 150 is located at the ends of a respective pair of adjacent tabs 116 and 118 and passes though the overlying openings formed in the arms 118 and 128 of that pair of adjacent tabs 116 and 126. More specifically, the assembly body 151 of the hinge/clutch assembly 150 is located adjacent to the bottom surface 112 of the tab or extension 116 and adjacent to the front surface 120 of the corresponding tab or extension 126. The assembly body 150 is also disposed adjacent to the overlying openings (not shown) formed in the arms 118 and 128 that extend from those two tabs 116 and 126. Further, the intermediate section (not shown) of the hinge/clutch assembly 150 extends through the overlying openings formed in these arms 118 and 128. Additionally, the end portion 152 of the hinge/clutch assembly 150 is located on an opposing side of the overlying openings formed in the arms 118 and 128, away from the tabs 116 and 126.

The pair of hinge/clutch assemblies 150 enable the upper or support plate 102 to be manually rotated about a pivot point 108 that is common to the two hinge/clutch assemblies 150. The range of rotation permitted by the pair of hinge/clutch assemblies 150 is shown by the angular path 154, shown in FIGS. 5 and 6. The range of rotation permitted by the pair of hinge/clutch assemblies 150 corresponds to the degree of tilt permitted to the upper or support plate 102.

After manual rotation, the clutch mechanism within each hinge/clutch assembly 150 holds the hinge/clutch assembly 150 in place and prevents inadvertent further rotation, that is, prevents change in the degree of tilt in the upper or support plate 102.

FIGS. 9-13 illustrate an example of an installation of an audiovisual device 210, such as a Crestron® Videobar 70, atop a tiltable tabletop mounting bracket 100.

FIG. 9 shows the mounting bracket 100 positioned atop a tabletop, credenza, or other suitable mounting surface 200. The audiovisual device 210, which may be the Crestron® Videobar 70, is to be mounted atop the mounting bracket 100. A pair of mounting screws 212 pass through the openings 114 in the upper or support plate 102 from below and secure the audiovisual device 210 to the upper plate 102.

FIG. 10 shows a rear perspective view of the audiovisual device 210 mounted to the upper plate 102 of the tabletop mounting bracket 100. Various data and power cables 214 have been routed through the opening 142 in the vertical wall 114 of the tabletop mounting bracket 100 and are connected to the audiovisual device 210. The data and power cables 214, for example, may have been routed through an opening in a wall. The data and power cables 214 may serve to provide power to the audiovisual device 210 and provide date connections between the audiovisual device 210 and displays and other conference room systems and devices.

A cable shroud 216 may be used to hide these exposed wires and cables. An example of such a cable shroud is described in U.S. application Ser. No. 29/987,910, titled “Cable Shroud for Electronic Device” and filed Jan. 28,2025, the disclosure of which is incorporated herein by reference.

FIG. 11 shows a front view of the audiovisual device 210 mounted to the upper plate 102 of the tabletop mounting bracket 100 and shows a front view of the cable shroud 216.

Because the tabletop mounting bracket 100 allows for tilting of the mounted audiovisual device 210, the mounting bracket 100 provides the advantage that the positioning of the audiovisual device 210 can still be optimized even after installation. After the audiovisual device 210 is mounted to the mounting bracket 100, and data connections are made to the actual conferencing equipment, the tilt of the audiovisual device 210 may be adjusted using the mounting bracket 100. Adjusting the tilt at this time may, for example, allow for the cameras and microphones of a Crestron® Videobar 70 to be best lined up for the particular conference room or lecture hall where the Videobar 70 has been installed.

Thus, the tiltable tabletop mounting bracket 100 provides for optimal use of the mounted audiovisual device 210.

### INDUSTRIAL APPLICABILITY

To solve the aforementioned problems, the present embodiments provide a tiltable mounting bracket that is suitable for placement atop a table or similar mounting surface and that is configured for mounting an audiovisual device, such as a Crestron® Videobar 70.

It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described as being in particular combinations, each feature or element may be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that may be derived from the description contained herein by a person skilled in the art. No element, act, or instruction used in the description of the present application should be construed as critical or essential to the embodiments unless explicitly described as such. Also, as used herein, the article “a” is intended to include one or more items.

In addition, the above disclosed methods are not meant to limit the aspects of the embodiments, or to suggest that the aspects of the embodiments should be implemented following the aforementioned methods. The purpose of the aforementioned methods is to facilitate the understanding of one or more aspects of the embodiments and to provide the reader with one or many possible implementations of the processed discussed herein. It should be understood by one of ordinary skill in the art that the steps of the aforementioned methods may be performed in a different order and that some steps may be eliminated or substituted.

All United States patents and applications, foreign patents, and publications discussed above are hereby incorporated herein by reference in their entireties.

### ALTERNATE EMBODIMENTS

Alternate embodiments may be devised without departing from the spirit or the scope of the embodiments.

What is claimed is:

1. A mounting bracket, comprising:
(a) a first plate configured to be disposed atop a horizontal mounting surface;
(b) a second plate configured to be securable to an audiovisual device;
(c) a third plate configured to extend from the first plate to at least near the second plate; and
(d) at least one hinge/clutch assembly having a pivot axis, the first plate and the third plate each being attached at one end to the at least one hinge/clutch assembly such that an angle between the second plate and the third plate is adjustable by rotating the second plate at least part way about the pivot axis of the at least one hinge/clutch assembly.

2. The mounting bracket of claim 1, wherein the first plate includes
(a) a first surface that is configured to face the mounting surface upon the first plate resting upon the mounting surface, and
(b) an opposing second surface that is configured to face away from the mounting surface upon the first plate resting upon the mounting surface.

3. The mounting bracket of claim 2, further comprising
(a) at least one grip pad attached to the first surface of the first plate.

4. The mounting bracket of claim 1, wherein the second plate includes
(a) a first surface that is configured to face the audiovisual device upon the audiovisual device being secured to the second plate, and
(b) an opposing second surface that is configured to face away from the audiovisual device upon the audiovisual device being secured to the second plate.

5. The mounting bracket of claim 4, wherein the third plate includes
(a) a first surface that is configured to face the at least one hinge/clutch assembly, and
(b) an opposing second surface that is configured to face away from the at least one hinge/clutch assembly.

6. The mounting bracket of claim 5, wherein the first plate includes
(a) a front part disposed on a same side of the third plate as the first surface of the third plate, and
(a) a back part disposed on a same side of the third plate as the second surface of the third plate.

7. The mounting bracket of claim 6,wherein
(a) a gap is formed between the front part and the back part of the first plate, the gap being configured to permit cabling of the audiovisual device to pass through the gap.

8. The mounting bracket of claim 5, wherein
(a) the one end of the second plate narrows to form at least one extension region, and
(b) a first arm is disposed adjacent to one side of the at least one extension region of the second plate and extends away from, and is perpendicular to, the second surface of the second plate.

9. The mounting bracket of claim 8, wherein
(a) the one end of the third plate narrows to form at least one further extension region, and
(b) a second arm disposed is adjacent to one side of the at least one further extension region of the third plate and extends away from, and is perpendicular to, the first surface of the third plate.

10. The mounting bracket of claim 9, wherein
(a) the first arm is disposed adjacent to the second arm and has an end portion that overlaps an end portion of the second arm, and
(b) a first opening formed in the end portion of the first arm overlies a second opening formed in the end portion of the second arm.

11. The mounting bracket of claim 10, wherein
(a) a body portion of the at least one hinge/clutch assembly is disposed on one side of the first and second openings, an end portion of the at least one hinge/clutch assembly is disposed on an opposing side of the first and second openings, and a remaining portion of the at least one hinge/clutch assembly extends through the first and second openings, and
(b) the pivot axis extends through the first and second openings.

12. The mounting bracket of claim 1,wherein
(a) a gap is formed between the second plate and the third plate, the gap being configured to permit cabling of the audiovisual device to pass through the gap.

13. The mounting bracket of claim 1, wherein
(a) the at least one hinge/clutch assembly is configured to be rotatable about the pivot axis upon exertion of a force on the second plate and to be fixed upon removal of the force.

14. A mounting bracket, comprising:
(a) a first plate configured to be disposed atop a horizontal mounting surface;
(b) a second plate configured to be securable to an audiovisual device, the second plate narrowing at one end to form at least one extension region, a first arm being disposed adjacent to one side of the at least one extension region and extending away from, and perpendicular to, a surface of the second plate;
(c) a third plate configured to extend from the first plate to at least near the second plate, the third plate narrowing at one end to form at least one further extension region, a second arm being disposed adjacent to one side of the at least one further extension region and extending away from, and perpendicular to, a surface of the third plate; and
(d) at least one hinge/clutch assembly having a pivot axis;
(e) wherein
(1) the first arm is disposed adjacent to the second arm and has an end portion that overlaps an end portion of the second arm,
(2) a first opening formed in the end portion of the first arm overlies a second opening formed in the end portion of the second arm,
(3) a body portion of the at least one hinge/clutch assembly is disposed on one side of the first and second openings, an end portion of the at least one hinge/clutch assembly is disposed on an opposing side of the first and second openings, and a remaining portion of the at least one hinge/clutch assembly extends through the first and second openings, and
(4) the pivot axis extends through the first and second openings, an angle between the second plate and the third plate thereby being adjustable by rotating the second plate at least part way about the pivot axis of the at least one hinge/clutch assembly.

15. The mounting bracket of claim 14, wherein
(a) the second plate narrows at one end to form a pair of extension regions, each having a respective first arm disposed adjacent to one side of that extension region and extending away from, and perpendicular to, the surface of the second plate.

16. The mounting bracket of claim 15, wherein
(a) the third plate narrows at one end to form a pair of further extension regions, each having a respective second arm disposed adjacent to one side of that further extension region and extending away from, and perpendicular to, the surface of the third plate.

17. The mounting bracket of claim 16, wherein
(a) the first arm of each one of the pair of extension regions is disposed adjacent to the second arm of a corresponding one of the pair of further extension regions and has an end portion that overlaps an end portion of that second arm, and
(b) a first opening formed in the end portion of each first arm overlies a second opening formed in the end portion of its adjacent second arm.

18. The mounting bracket of claim 17, wherein
(a) the at least one hinge/clutch assembly comprises
(1) a pair of hinge/clutch assemblies,
(2) an end of one of the pair of extension regions of the second plate and an adjacent end of one of the pair of further extension regions of the third plate are each attached to one of the pair of hinge/clutch assemblies, and
(3) an end of another of the pair of extension regions of the second plate and an adjacent end of another of the pair of further extension regions of the third plate are each attached to another of the pair of hinge/clutch assemblies, whereby
(4) the pair of hinge/clutch assemblies have a common pivot axis.

19. The mounting bracket of claim 18, wherein
(a) each one of the pair of hinge/clutch assemblies is configured to be rotatable about the common pivot axis upon exertion of a force on the second plate and to be fixed upon removal of the force.

20. A mounting bracket, comprising:
(a) a first plate configured to be disposed atop a horizontal mounting surface, the first plate including
(1) a first surface that is configured to face the mounting surface upon the first plate resting upon the mounting surface, and
(2) an opposing second surface that is configured to face away from the mounting surface upon the first plate resting upon the mounting surface;
(b) a second plate configured to be securable to an audiovisual device, the second plate including
(1) a first surface that is configured to face the audiovisual device upon the audiovisual device being secured to the second plate, and
(2) an opposing second surface that is configured to face away from the audiovisual device upon the audiovisual device being secured to the second plate,
(3) the second plate narrowing at one end to form a pair of extension regions, each having a respective first arm disposed adjacent to one side of that extension region and extending away from, and perpendicular to, the second surface of the second plate;
(c) a third plate configured to extend from the first plate to at least near the second plate, the third plate the third plate including
(1) a first surface that is configured to face the at least one hinge/clutch assembly, and
(2) an opposing second surface that is configured to face away from the at least one hinge/clutch assembly,
(3) the third plate narrowing at one end to form a pair of further extension regions, each having a respective second arm disposed adjacent to one side of that further extension region and extending away from, and perpendicular to, the first surface of the third plate, wherein
(4) the first arm that extends from each one of the pair of extension regions of the second plate is disposed adjacent to the second arm that extends from a corresponding one of the pair of further extension regions of the third plate and has an end portion that overlaps an end portion of that second arm, and
(5) a first opening formed in the end portion of each first arm overlies a second opening formed in the end portion of its adjacent second arm; and
(d) a pair of hinge/clutch assemblies, wherein
(1) an ending of one of the pair of extension regions of the second plate and an adjacent ending of one of the pair of further extension regions of the third plate are each attached to a respective one of the pair of hinge/clutch assemblies, such that
(A) a body portion of that hinge/clutch assembly is disposed on one side of the overlying first and second openings respectively formed in the end portions of the first and second arms that respectively extend from one of the pair of extension regions of the second plate and the one of the pair of further extension regions of the third plate,
(B) an end portion of that hinge/clutch assembly is disposed on an opposing side of the overlying first and second openings, and
(C) a remaining portion of that hinge/clutch assembly extends through the overlying first and second openings, and
(2) an ending of another of the pair of extension regions of the second plate and an adjacent ending of another of the pair of further extension regions of the third plate are each attached to another of the pair of hinge/clutch assemblies, such that
(A) a body portion of that hinge/clutch assembly is disposed on one side of the overlying first and second openings respectively formed in the end portions of first and second arms that respectively extend from another of the pair of extension regions of the second plate and another of the pair of further extension regions of the third plate,
(B) an end portion of that hinge/clutch assembly is disposed on an opposing side of the overlying first and second openings, and
(C) a remaining portion of that hinge/clutch assembly extends through the overlying first and second openings,
(3) the pair of hinge/clutch assemblies thereby having a common pivot axis, each one of the pair of hinge/clutch assemblies being configured to be rotatable about the common pivot axis upon exertion of a force on the second plate and to be fixed upon removal of the force;
(e) wherein
(1) the first plate includes
(A) a front part disposed on a same side of the third plate as the first surface of the third plate, and
(B) a back part disposed on a same side of the third plate as the second surface of the third plate,
(2) a first gap is formed between the front part and the back part of the first plate, the first gap being configured to permit cabling of the audiovisual device to pass through the first gap, and
(3) a second gap is formed between the second plate and the third plate, the second gap being configured to permit cabling of the audiovisual device to pass through the second gap.
